(19) United States
(12) Patent Application Publication
(10) Pub. No.: US 2025/0251886 A1
(43) Pub. Date: Aug. 7, 2025

(54) INTEGRATED PRINTING SYSTEM, SERVICE LINKING DEVICE, AND PRINT MANAGEMENT DEVICE

(71) Applicant: SEIKO EPSON CORPORATION, Tokyo (JP)

(72) Inventors: Shigeyoshi MIYAZAWA, MATSUMOTO-SHI (JP); Hiroyuki KURAMOTO, SHIOJIRI-SHI (JP); Toshiaki MIZUTA, NISHITOKYO-SHI (JP)

(21) Appl. No.: 19/042,338

(22) Filed: Jan. 31, 2025

(30) Foreign Application Priority Data
Feb. 2, 2024 (JP) 2024-014729

(51) Int. Cl. G06F 3/12

(52) U.S. Cl. CPC G06F 3/1268; G06F 3/1203

(57) ABSTRACT

An integrated printing system includes a first print management server, a second print management server, and a service linking server. When receiving a print instruction designating job identification information, the second print management server transmits job identification information to the service linking server. The service linking server includes a transfer control unit configured to acquire issuance source information included in the job identification information received from the second print management server and transfer, to the second print management server, print data corresponding to the job identification information stored by the first print management server indicated by the issuance source information.

The present application is based on, and claims priority from JP Application Serial Number 2024-014729, filed Feb. 2, 2024, the disclosure of which is hereby incorporated by reference herein in its entirety.

### BACKGROUND

### 1. Technical Field

The present disclosure relates to an integrated printing system, a service linking device, and a print management device.

### 2. Related Art

There has been known a system in which a user registers print data desired to be printed in the cloud in advance, goes to a store, and downloads print data to a printing device installed in the store and prints the print data.

For example, an image forming apparatus disclosed in JP-A-2016-19208 includes an imaging device and downloads, from a server, document data correlated with biometrics information coinciding with biometrics information obtained from an image of a face captured by an imaging device. An image forming apparatus installed in a store such as a convenience store executes printing based on the downloaded document data.

JP-A-2016-19208 is an example of the related art.

However, even if the user goes to the store and attempts to print the printing data, when the device installed in the store and the server that has registered the print data are operating as different systems, the user cannot download and print the print data registered in the server.

### SUMMARY

According to an aspect of the present disclosure, there is provided an integrated printing system including: a first print management device including: a first reception unit configured to receive print data; a first storage unit configured to store the print data; a first issuance unit configured to issue identification information of a job corresponding to the print data, the identification information being job identification information including issuance source information indicating a print management device at an issuance source of the job; and a first transmission unit configured to transmit the job identification information to a user at a transmission source of the print data and a service linking device that manages the job identification information; the service linking device including: an information acquisition unit configured to acquire the job identification information from the first print management device; and a management unit configured to manage the job identification information; and a second print management device including: a second acquisition unit configured to, when receiving a print instruction designating the job identification information, transmit the job identification information to the service linking device and acquire, from the print management device indicated by the issuance source information included in the job identification information, print data corresponding to the designated job identification information; and a second print control unit configured to execute print processing based on the acquired print data, in which the service linking device includes a transfer control unit configured to acquire the issuance source information included in the job identification information received from the second print management device and transfers, to the second print management device, the print data corresponding to the job identification information stored by the first print management device indicated by the acquired issuance source information.

According to an aspect of the present disclosure, there is provided a service linking device including: an information acquisition unit configured to acquire, from a print management device that stores print data, identification information of a job corresponding to the print data, the identification information being job identification information including issuance source indicating the print management device that is an issuance source of the job; a third storage unit configured to store the job identification information acquired by the information acquisition unit and identification information of the print management device indicated by the issuance source information; and a transfer control unit configured to acquire the issuance source information included in the job identification information received from another print management device and transfer, to the other print management device, the print data corresponding to the job identification information stored by the print management device indicated by the acquired issuance source information.

According to an aspect of the present disclosure, there is provided a print management device including: a first reception unit configured to receive print data; a first storage unit configured to store the print data; and a first issuance unit configured to issue identification information of a job corresponding to the print data, the identification information being job identification information including issuance source information indicating a print management device at an issuance source of the job, the print management device transmitting the job identification information to a user at a transmission source of the print data and a service linking device that manages the job identification information and, when receiving the job identification information and a transfer request for the print data, transmitting the print data corresponding to the job identification information to another print management device designated by the transfer request.

According to an aspect of the present disclosure, there is provided a print management device including: a second acquisition unit configured to, when receiving a print instruction designating identification information of a job corresponding to print data, the identification information being job identification information including issuance source information indicating a print management device at an issuance source of the job, inquire a service linking device, which manages the job identification information, about the job identification information and acquire, from the print management device indicated by the issuance source information included in the job identification information, the print data corresponding to the designated job identification information; and a second print control unit configured to execute print processing based on the acquired print data.

### BRIEF DESCRIPTION OF THE DRAWINGS

FIG. 1 is a system configuration diagram of an integrated printing system.

FIG. 2 is a block diagram illustrating a configuration of a first print management server.

FIG. 3 is a block diagram illustrating a configuration of a second print management server.

FIG. 4 is a diagram illustrating an example of a configuration of a user management DB.

FIG. 5 is a block diagram illustrating a configuration of a service linking server.

FIG. 6 is a diagram illustrating an example of a configuration of a server registration table.

FIG. 7 is a diagram illustrating an example of a configuration of a job setting DB.

FIG. 8 is a flowchart illustrating an operation of the first print management server.

FIG. 9 is a flowchart illustrating an operation of the service linking server.

FIG. 10 is a flowchart illustrating an operation of the second print management server.

### DESCRIPTION OF EMBODIMENTS

### 1. Configuration of an Integrated Printing System

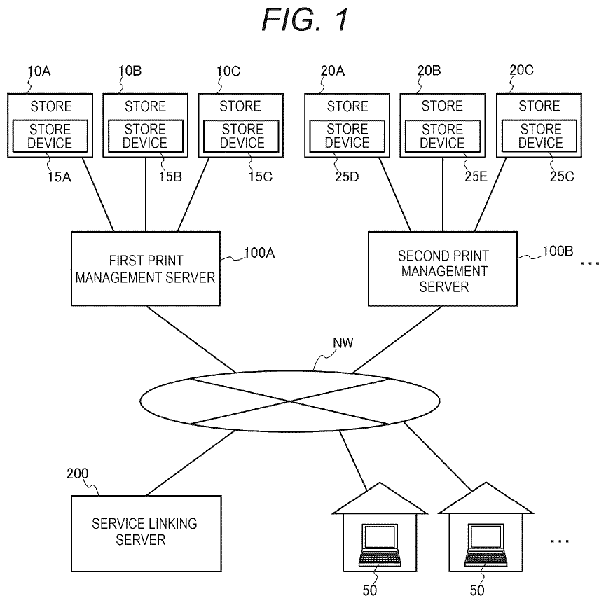

FIG. 1 is a diagram illustrating a system configuration of an integrated printing system 1.

The integrated printing system 1 includes a plurality of operation terminals 50, store devices 15 respectively installed in a plurality of stores 10 and 20, a first print management server 100A, a second print management server 100B, and a service linking server 200. The first print management server 100A is equivalent to a first print management device and a print management device. The second print management server 100B is equivalent to a second print management device and the print management device. The service linking server 200 is equivalent to a service linking device.

The operation terminal 50 is a terminal device that receives operation of a user. The operation terminal 50 is installed in, for example, the user's home or a building including a company to which the user belongs. The operation terminal 50 may be a personal computer of a desktop type, a notebook type, a tablet type, or the like or may be a smartphone carried by the user. The user is a user registered in the first print management server 100A or the second print management server 100B belonging to the integrated printing system 1.

In FIG. 1, two servers, that is, the first printing management server 100A and the second print management server 100B are illustrated as print management servers 100. However, the number of print management servers 100 provided in the integrated printing system 1 is not limited to two and may be three or more. In the following explanation, the first print management server 100A and the second print management server 100B are collectively referred to as print management server 100.

The first print management server 100A, the second print management server 100B, and the service linking server 200 are connected to one another to be capable of performing data communication via a communication network NW.

The communication network NW may be a Local Area Network (LAN) or may be a global network including a dedicated line, a public switched network, and the Internet. The communication network NW may be a wireless communication network such as Wi-Fi. Wi-Fi is a registered trademark.

The first print management server 100A is a server that provides a first print service to a registered user. The first print management server 100A is connected to store devices 15A, 15B, 15C, . . . installed in registered stores 10A, 10B, 10C, . . . to be capable of performing data communication. The store devices 15A, 15B, 15C, . . . are collectively referred to as store device 15. The store device 15 includes an operation unit that receives operation by the user, a display device such as a liquid crystal panel, and a printing unit that prints print data on a print medium according to print setting information. The operation unit, the display device, and the printing unit are not illustrated.

The first print management server 100A stores a print job uploaded from the operation terminal 50. The print job includes print data and print setting information. The print setting information is setting information in printing the print data and includes, for example, information such as a size and a type of paper on which the print data is printed, print quality, black-and-white printing or color setting, duplex printing, and the number of copies.

The first print management server 100A downloads, based on operation of the user in the store device 15, a print job corresponding to the operation to the store device 15 and causes the store device 15 to execute print processing based on the print setting information.

The second print management server 100B is also a server that provides a second print service to the registered user. The second print management server 100B is connected to store devices 25A, 25B, 25C, . . . installed in the registered stores 20A, 20B, 20C, . . . to be capable of performing data communication. The store devices 25A, 25B, 25C, . . . are collectively referred to as store device 25. The first print service and the second print service are, for example, different services operated by different companies. The store device 25 includes an operation unit that receives operation of the user, a display device such as a liquid crystal panel, and a printing unit that prints print data on a print medium according to print setting information. The operation unit, the display device, and the printing unit are not illustrated.

The second print management server 100B downloads, based on operation of the user in the store device 25, a print job corresponding to the operation to the store device 25 and causes the store device 25 to execute print processing based on the print setting information.

The service linking server 200 is a server that links the first print service provided by the first print management server 100A and the second print service provided by the second print management server 100B. The service linking server 200 is a server that provides a service for printing, in the store device 25 of the store 20 registered as a provision place of the second print service provided by the second print management server 100B, the print data registered in the first print management server 100A. The service linking server 200 is a server that provides a service for printing, in the store device 15 of the store 10 registered as a provision place of the first print service provided by the first print management server 100A, the print data registered in the second print management server 100B.

### 2. Configuration of the First and Second Print Management Server

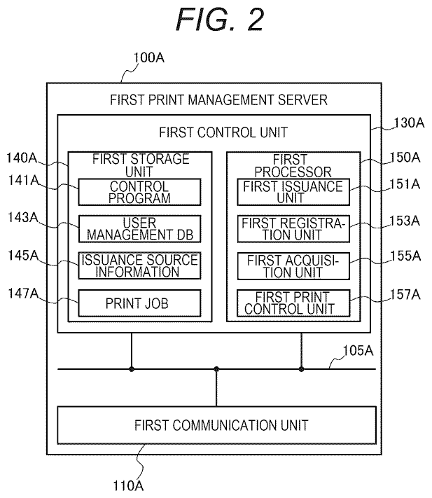

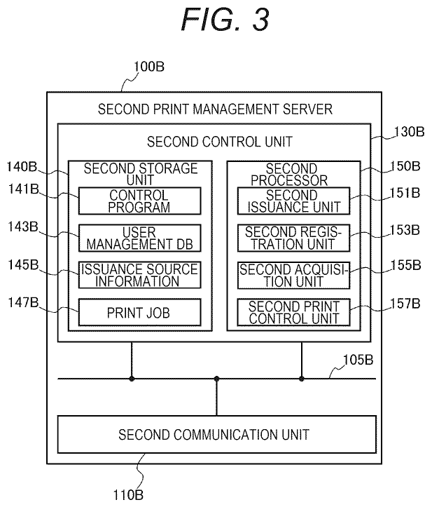

FIG. 2 is a block diagram illustrating a configuration of the first print management server 100A. FIG. 3 is a block diagram illustrating a configuration of the second print management server 100B. The configurations of the first print management server 100A and the second print management server 100B are substantially the same. For this reason, in the following explanation, the configuration of the first print management server 100A is explained and explanation of the configuration of the second print management server 100B is omitted.

The first print management server 100A includes a first communication unit 110A and a first control unit 130A. The first communication unit 110A and the first control unit 130A are connected to a communication bus 105A to be capable of performing data communication. The first communication unit 110A is equivalent to a first reception unit and a first transmission unit.

The first communication unit 110A is, for example, a wired communication interface including a connection terminal such as an Ethernet connector or a universal serial bus (USB) connector and an interface circuit. The first communication unit 110A is connected to the communication network NW and performs data communication with the second print management server 100B and the service linking server 200 connected to the communication network NW. Ethernet is a registered trademark.

The first control unit 130A is a computer including a first storage unit 140A and a first processor 150A.

The first storage unit 140A includes a volatile memory such as a random access memory (RAM) and a nonvolatile memory such as a read only memory (ROM). The first storage unit 140A includes an auxiliary storage device such as a solid state drive (SSD) or a hard disk drive (HDD).

The first storage unit 140A stores a control program 141A to be executed by the first processor 150A, a user management database 143A, issuance source information 145A, and a print job 147A. Database is abbreviated as DB below.

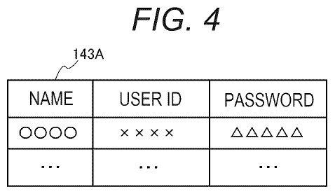

FIG. 4 is a diagram illustrating an example of a configuration of the user management DB 143A.

The user management DB 143A is a database for managing authentication information of a registered user. One record of the user management DB 143A includes a name of the user, a user ID, and a password. Besides, information such as an address, age, and sex can also be included in one record as information for specifying the user.

The issuance source information 145A is information indicating the print management server 100 at an issuance source of a print job. Specifically, the issuance source information 145A indicates the first print management server 100A and the issuance source information 145B indicates the second print management server 100B.

The issuance source information 145A is information included in job identification information issued by the first print management server 100A. The job identification information is information for identifying a print job received from the operation terminal 50.

The print job 147A is a print job received from the operation terminal 50. The print job 147A is stored in the first storage unit 140A in association with the job identification information.

The first processor 150A is an arithmetic processing device configured by a central processing unit (CPU) or a micro-processing unit (MPU). The first processor 150A executes the control program 141A to control the units of the first print management server 100A. The first processor 150A may be configured by a single processor or can also be configured by a plurality of processors.

The first control unit 130A includes a first issuance unit 151A, a first registration unit 153A, a first acquisition unit 155A, and a first print control unit 157A as functional blocks. These functional blocks are functions implemented by the first processor 150A executing an arithmetic operation conforming to the control program 141A.

When receiving a print job from the operation terminal 50, the first issuance unit 151A issues job identification information that is identification information for identifying the print job. The job identification information includes issuance source information. The print job includes print data and print setting information. The issuance source information is information indicating that an issuance source of the job identification information is the first print management server 100A.

The first registration unit 153A causes the first storage unit 140A to store the job identification information issued by the first issuance unit 151A in association with the print job received from the operation terminal 50.

The first registration unit 153A transmits the job identification information issued by the first issuance unit 151A to the operation terminal 50.

Further, the first registration unit 153A transmits a registration request for the print job to the service linking server 200. The registration request for the print job includes the job identification information and print setting information included in the print job received from the operation terminal 50. The first registration unit 153A generates information indicating a data amount of the print data and transmits the print setting information including the generated data amount to the service linking server 200.

When receiving a print instruction designating job identification information from the store device 15, the first acquisition unit 155A acquires print data and print setting information of a print job corresponding to the designated job identification information.

First, the first acquisition unit 155A acquires issuance source information included in the job identification information designated by the print instruction. The first acquisition unit 155A collates the acquired issuance source information and the issuance source information 145A stored by the first storage unit 140 to determine whether the acquired issuance source information indicates the first print management server 100A itself.

When the acquired issuance source information indicates the first print management server 100A itself, the first acquisition unit 155A outputs a print instruction to the first print control unit 157A.

The first print control unit 157A acquires, from the first storage unit 140, print data and print setting information corresponding to job identification information designated by the print instruction input from the first acquisition unit 155A. The first print control unit 157A transmits the acquired print data and the acquired print setting information to the store device 15 that has received the print instruction. The store device 15 executes print processing based on the print data according to the print setting information received from the first print management server 100A.

When determining that the acquired issuance source information indicates another print management server 100, the first acquisition unit 155A transmits an acquisition request for a print job including the designated job identification information to the service linking server 200. The job identification information is job identification information designated by the print instruction.

Thereafter, when receiving a print job from the service linking server 200 or the print management server 100 corresponding to the issuance source information, the first acquisition unit 155A outputs the received print job to the first print control unit 157A. The first print control unit 157A transmits the acquired print data and the acquired print setting information to the store device 15 that has received the print instruction.

### 3. Configuration of the Service Linking Server

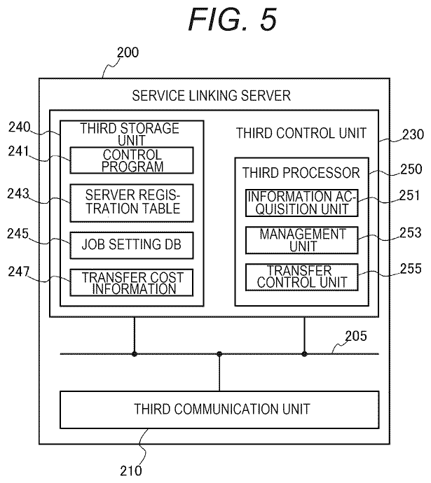

FIG. 5 is a diagram illustrating an example of a configuration of the service linking server 200.

The configuration of the service linking server 200 is explained with reference to FIG. 5.

The service linking server 200 includes a third communication unit 210 and a third control unit 230. The third communication unit 210 and the third control unit 230 are connected by a communication bus 205 to be capable of performing data communication.

The third communication unit 210 is, for example, a wired communication interface including a connection terminal such as an Ethernet connector or a USB connector and an interface circuit. The third communication unit 210 is connected to the communication network NW and performs data communication with the first print management server 100A and the second print management server 100B connected to the communication network NW.

The third control unit 230 is a computer including a third storage unit 240 and a third processor 250.

The third storage unit 240 includes a volatile memory such as a RAM and a nonvolatile memory such as a ROM. The third storage unit 240 includes an auxiliary storage device such as an SSD or an HDD.

The third storage unit 240 stores a control program 241 to be executed by the third processor 250, a server registration table 243, a job setting DB 245, and transfer cost information 247.

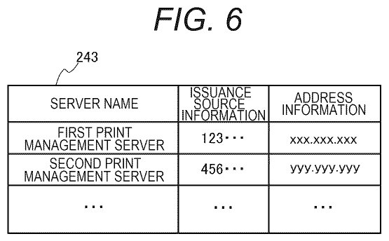

FIG. 6 is a diagram illustrating an example of a configuration of the server registration table 243.

One record of the server registration table 243 includes a server name, issuance source information, and address information such as an IP address. The server name and the address information are equivalent to identification information of a print management device indicated by the issuance source information.

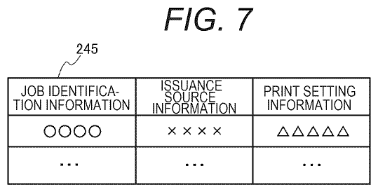

FIG. 7 is a diagram illustrating an example of a configuration of the job setting DB 245.

One record of the job setting DB 245 includes job identification information, issuance source information, and print setting information.

The job identification information is information included in a registration request for a print job received from the first print management server 100A or the second print management server 100B.

The issuance source information is issuance source information included in the job identification information of the same record.

The print setting information is information included in the registration request for the print job.

The transfer cost information 247 is information used for calculating cost necessary when transferring the print job between the print management servers 100. For example, the transfer cost information 247 is information in which a data amount of the print job and transfer cost required to transfer data having the data amount are registered in association with each other.

The third processor 250 is an arithmetic processing device configured by a CPU or an MPU. The third processor 250 executes the control program 241 to control the respective units of the service linking server 200. The third processor 250 may be configured by a single processor or can also be configured by a plurality of processors.

The third control unit 230 includes an information acquisition unit 251, a management unit 253, and a transfer control unit 255 as functional blocks. These functional blocks are functions implemented by the third processor 250 executing processing conforming to the control program 241.

The information acquisition unit 251 acquires job identification information from the first print management server 100A and the second print management server 100B.

The information acquisition unit 251 acquires a registration request for a print job and an acquisition request for a print job received by the third communication unit 210 from the first print management server 100A or the second print management server 100B.

When acquiring the registration request for the print job, the information acquisition unit 251 extracts job identification information and print setting information included in the acquired registration request for the print job and outputs the extracted job identification information and the extracted print setting information to the management unit 253. When acquiring the acquisition request for the print job, the information acquisition unit 251 extracts job identification information included in the acquisition request for the acquired print job and outputs the extracted job identification information to the transfer control unit 255.

The management unit 253 extracts issuance source information included in the job identification information input from the information acquisition unit 251 and registers the print setting information and the issuance source information in the job setting DB 245 in association with the job identification information.

The transfer control unit 255 refers to the server registration table 243 based on the issuance source information included in the job identification information input from the information acquisition unit 251 and specifies the print management server 100 that stores print data. The transfer control unit 255 acquires address information of the specified print management server 100 from the server registration table 243. In the following explanation, it is assumed that the specified print management server 100, the address information of which has been acquired, is the first print management server 100A and the transfer control unit 255 acquires the address information of the first print management server 100A from the server registration table 243.

Subsequently, the transfer control unit 255 acquires transfer cost required for transferring print data and the like. The information acquisition unit 251 may calculate the transfer cost based on the transfer cost information 247 and the data amount included in the print setting information. The information acquisition unit 251 may acquire preset transfer cost from the third storage unit 240.

When acquiring the transfer cost, the transfer control unit 255 returns the acquired transfer cost and the print setting information to the print management server 100 at a transmission source of the acquisition request for the print job. For example, it is assumed that the transmission source of the acquisition request for the print job is the second print management server 100B. When receiving the transfer cost and the print setting information from the service linking server 200, the second print management server 100B calculates print cost, which is cost required for printing the print data, based on the print setting information. The second print management server 100B transmits the transfer cost and the print cost to the store device 25.

The store device 25 causes a display device provided in the store device 25 to display the transfer cost and the print cost or a total amount of the transfer cost and the print cost and inquires of the user whether to execute printing. When receiving operation for instructing print execution from the user, the store device 25 notifies the second print management server 100B that the instruction for the print execution has been received. The second print management server 100B notifies the service linking server 200 that the instruction for the print execution has been received.

When receiving the instruction for the print execution from the second print management server 100B and acquiring the transfer cost, the transfer control unit 255 distributes the acquired transfer cost to the service linking server 200 and the first print management server 100A. The service linking server 200 distributes cost of the first print management server 100A in the transfer costs acquired from the second print management server 100B to the first print management server 100A.

Subsequently, the transfer control unit 255 transmits a transfer request for a print job including job identification information and address information to the first print management server 100 corresponding to the address information acquired from the server registration table 243. The address information included in the transfer request for the print job is an address of the print management server 100 at a transfer destination to which the print job is transferred. That is, the address information is an address of the second print management server 100B.

When receiving a transfer request for a print job, the first print management server 100A acquires, from the first storage unit 140A, print data and print setting information of a print job corresponding to job identification information included in the received transfer request. The first print management server 100A transmits the acquired print job to an address indicated by address information included in the transfer request.

The transfer control unit 255 may transmit, as the transfer request for the print job, to the first print management server 100, a request for transferring the print job to the service linking server 200. In this case, the transfer request for the print job does not include the address information, that is, the address of the print management server 100 at a transfer destination to which the print job is transferred. In this case as well, when receiving a transfer request for a print job, the first print management server 100A acquires, from the first storage unit 140A, print data and print setting information of a print job corresponding to job identification information included in the received transfer request. The first print management server 100A transmits the acquired print job to the service linking server 200.

When receiving the print job from the first print management server 100A, the service linking server 200 transmits the received print job to the second print management server 100B that is a request source of the acquisition request for the print job.

### 4. Operations of the Print Management Server and the Service Linking Server

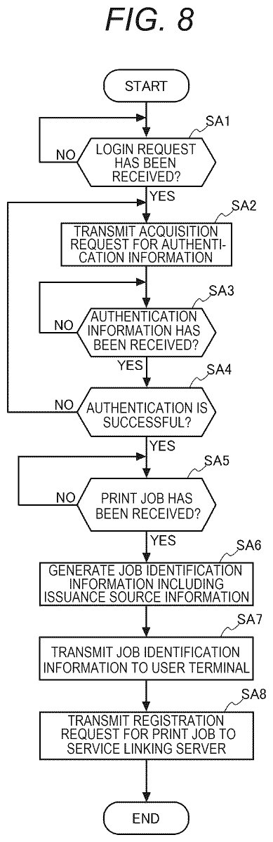

FIG. 8 is a flowchart illustrating an operation of the print management server 100 in the case in which a registration request for a print job is received. In the flowchart of FIG. 8, a case in which the print management server 100 having received the registration request for the print job is the first print management server 100A is explained.

First, the first control unit 130A determines whether a login request has been received from the operation terminal 50 (step SA1). When a login request has not been received (step SA1/NO), the first control unit 130A stays on standby until a login request is received.

When receiving a login request from the operation terminal 50 (step SA1/YES), the first control unit 130A transmits an acquisition request for authentication information to the operation terminal 50 that is a transmission source of the login request (step SA2) and determines whether authentication information has been received (step SA3).

When authentication information has not been received (step SA3/NO), the first control unit 130A stays on standby until authentication information is received. When receiving authentication information (step SA3/YES), the first control unit 130A determines whether the received authentication information and the authentication information registered in the user management DB 143A coincide and determines whether authentication has been successful (step SA4).

When the received authentication information and the authentication information registered in the user management DB 143A do not coincide and the first control unit 130A determines that the authentication has been unsuccessful (step SA4/NO), the first control unit 130A returns to step SA2 and requests retransmission of authentication information (step SA2).

When the received authentication information and the authentication information registered in the user management DB 143A coincide (step SA4/YES), the first control unit 130A determines whether a print job has been received from the operation terminal 50 (step SA5). The print job includes print data and print setting information.

When a print job has not been received (step SA5/NO), the first control unit 130A stays on standby until a print job is received. When receiving a print job (step SA5/YES), the first control unit 130A generates job identification information (step SA6). The job identification information includes issuance source information indicating an issuance source of the job identification information.

Subsequently, the first control unit 130A transmits the generated job identification information to the operation terminal 50 at a request source (step SA7). Subsequently, the first control unit 130A transmits a registration request for a print job to the service linking server 200 (step SA8). The registration request for the print job includes job identification information and print setting information.

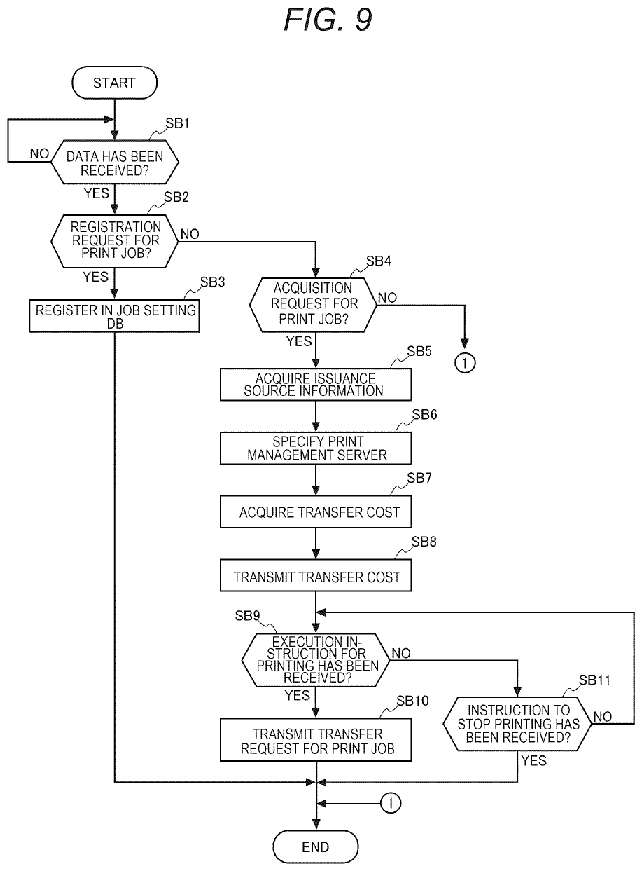

FIG. 9 is a flowchart illustrating an operation of the service linking server 200.

The operation of the service linking server 200 is explained with reference to the flowchart of FIG. 9.

First, the third control unit 230 determines whether data has been received by the third communication unit 210 (step SB1). When data has not been received by the third communication unit 210 (step SB1/NO), the third control unit 230 stays on standby until data is received.

When data is received by the third communication unit 210 (step SB1/YES), the third control unit 230 determines whether the received data is a registration request for a print job (step SB2).

When the received data is not a registration request for a print job (step SB2/NO), the third control unit 230 shifts to processing in step SB4.

When the received data is a registration request for a print job (step SB2/YES), the third control unit 230 extracts issuance source information from job identification information included in the registration request for the print job. The third control unit 230 registers the extracted issuance source information and the print setting information included in the print job in the job setting DB 245 in association with the job identification information (step SB3) and ends the processing.

When the received data is not a registration request for a print job (step SB2/NO) and is an acquisition request for a print job (step SB4/YES), the third control unit 230 acquires issuance source information from job identification information included in the acquisition request for the print job (step SB5).

Subsequently, the third control unit 230 refers to the server registration table 243 to specify the print management server 100 indicated by the acquired issuance source information (step SB6) and acquires address information of the specified print management server 100.

Subsequently, the third control unit 230 refers to the job setting DB 245 based on the job identification information and acquires print setting information associated with the job identification information. The third control unit 230 calculates transfer cost of the print job based on a data amount included in the print setting information and the transfer cost information 247 to acquire the transfer cost (step SB7).

The third control unit 230 returns the acquired transfer cost and the print setting information to the print management server 100 at a transmission source of the acquisition request for the print job. When receiving the transfer cost and the print setting information from the service linking server 200, the print management server 100 calculates print cost, which is cost required for printing the print data, based on the print setting information. The first print management server 100A transmits the calculated transfer cost and the calculated print cost to the store device 15 or 25 (step SB8).

The store device 15 or 25 causes a display device to display the received transfer cost and the received print cost and receives an instruction to execute printing or stop printing. When receiving the instruction to execute printing or stop printing, the store device 15 or 25 transmits the received instruction to execute printing or stop printing to the printing management server 100. The print management server 100 transfers, to the service linking server 200, the instruction to execute printing or stop printing received from the store device 15 or 25.

When receiving the instruction to execute printing from the print management server 100 (step SB9), the third control unit 230 transmits a transfer request for a print job to the print management server 100 specified in step SB6 (step SB10). At this time, the print management server 100 having received the transfer request performs processing for specifying a print job corresponding to job identification information included in the transfer request and transmitting the print job to the print management server 100 having address information included in the transfer request. As explained above, the print management server 100 having received the print job performs processing for printing the received print job. When not receiving the instruction to execute printing (step SB9/NO) and receiving the instruction to stop printing from the print management server 100 (step SB11/YES), the third control unit 230 ends this processing flow. When the instruction to stop printing has not been received (step SB11/NO), the third control unit 230 returns to the determination in step SB9.

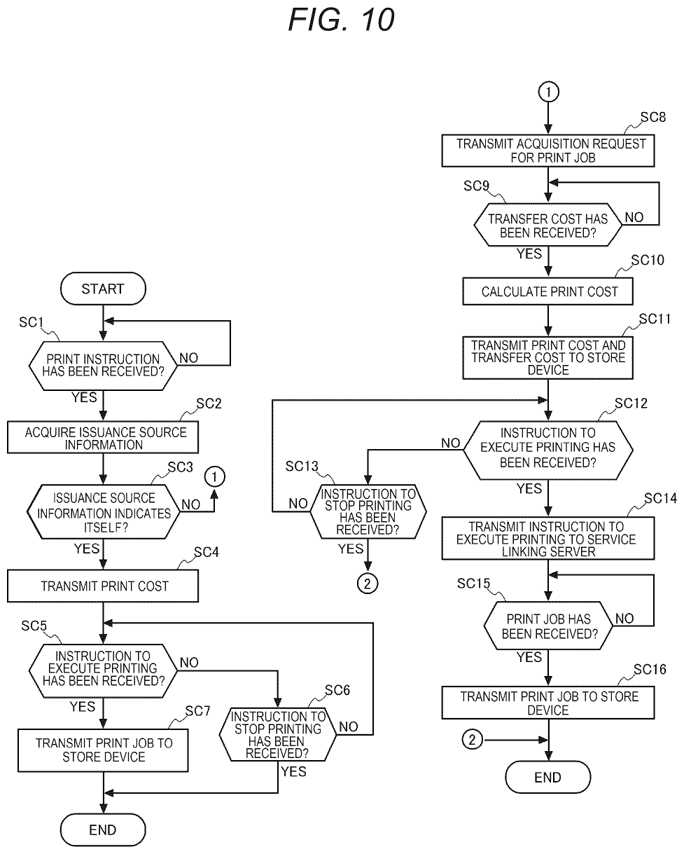

FIG. 10 is a flowchart illustrating the operation of the print management server 100 that has received the print instruction. An operation of the print management server 100 is explained with reference to the flowchart of FIG. 10.

In the following explanation, it is assumed that the print management server 100 that has received the print instruction is the second print management server 100B.

First, a second control unit 130B determines whether a print instruction including job identification information has been received from the store device 25 (step SC1). When the print instruction has not been received (step SC1/NO), the second control unit 130B stays on standby until the print instruction is received.

When receiving the print instruction (step SC1/YES), the second control unit 130B acquires issuance source information from the job identification information included in the print instruction (step SC2). The second control unit 130B determines whether the acquired issuance source information indicates the second print management server 100B (step SC3).

When the acquired issuance source information indicates the second print management server 100B (step SC3/YES), the second control unit 130B calculates print cost and transmits the calculated print cost to the store device 25 (step SC4).

The store device 25 causes the display device to display the received print cost and receives an instruction to execute printing or stop printing. The store device 25 transmits the received instruction to execute printing or stop printing to the second print management server 100B.

When receiving the instruction to execute printing from the store device 25 (step SC5/YES), the second control unit 130B transmits print data and print setting information to the store device 25 (step SC7). The store device 25 executes print processing based on the print data according to the received print setting information.

When not receiving the instruction to execute printing (step SC5/NO) and receiving the instruction to stop printing from the store device 25 (step SC6/YES), the second control unit 130B ends this processing flow.

When the instruction to stop printing has not been received from the store device 25 (step SC6/NO), the second control unit 130B returns to step SC5 and determines whether the instruction to execute printing has been received (step SC5).

When the acquired issuance source information indicates another print management server 100 (step SC3/NO), the second control unit 130B transmits an acquisition request for a print job to the service linking server 200 (step SC8).

Subsequently, the second control unit 130B determines whether data transfer cost and print setting information have been received from the service linking server 200 (step SC9). When transfer cost has not been received from the service linking server 200 (step SC9/NO), the second control unit 130B stays on standby until transfer cost is received.

When receiving transfer cost (step SC9/YES), the second control unit 130B calculates print cost, which is cost of printing, based on the print setting information (step SC10). The second control unit 130B transmits the calculated print cost and the received transfer cost to the store device 25 (step SC11).

The store device 25 causes the display device to display the received print cost and the received transfer cost or a total amount of the transfer cost and the print cost and receives an instruction to execute printing or stop printing. The store device 25 transmits the received instruction to execute printing or stop printing to the second print management server 100B.

When receiving the instruction to execute printing from the store device 25 (step SC12/YES), the second control unit 130B transmits the instruction to execute printing to the service linking server 200 (step SC14). Then, the second control unit 130B determines whether a print job has been received from the service linking server 200 or the print management server 100 that stores the print job (step SC15).

When a print job has not been received (step SC15/NO), the second control unit 130B stays on standby until a print job is received. When receiving a print job (step SC15/YES), the second control unit 130B transmits the received print job to the store device 25 (step SC16). The store device 25 executes print processing based on the print data according to the received print setting information.

When not receiving the instruction to execute printing (step SC12/NO) and receiving the instruction to stop printing from the store device 25 (step SC13/YES), the second control unit 130B ends this processing flow.

When the instruction to stop printing has not been received (step SC13/NO), the second control unit 130B returns to the determination in step SC12.

### 5. Effects

As explained above, the integrated printing system 1 in the present embodiment includes the first print management server 100A, the service linking server 200, and the second print management server 100B.

The first print management server 100A includes the first communication unit 110A, the first storage unit 140A, and the first issuance unit 151A.

The first communication unit 110A receives print data. The first communication unit 110A transmits job identification information to a user at a transmission source of the print data and the service linking server 200 that manages the job identification information.

The first storage unit 140A stores the print data.

The first issuance unit 151A issues identification information of a job corresponding to the print data, the identification information being job identification information including issuance source information indicating the print management server 100 at an issuance source of the job.

The service linking server 200 includes the information acquisition unit 251 that acquires job identification information from the first print management server 100A and the management unit 253 that manages the job identification information.

The second print management server 100B includes a second acquisition unit 155B and a second print control unit 157B.

When receiving a print instruction specifying the job identification information, the second acquisition unit 155B transmits the job identification information to the service linking server 200 and acquires print data corresponding to the designated job identification information from the print management server 100 indicated by the issuance source information included in the job identification information.

The second print control unit 157B executes print processing based on the acquired print data.

The service linking server 200 further includes the transfer control unit 255 that specifies the issuance source information based on the job identification information received from the second print management server 100B and transfers, to the second print management server 100B, the print data corresponding to the job identification information stored in the first print management server 100A based on the issuance source information.

With this configuration, when receiving the print instruction designating the job identification information, the second print management server 100B inquires of the service linking server 200 about the job identification information and the service linking server 200 specifies the issuance source information based on the job identification information and transfers, to the second print management server 100B, the print data corresponding to the job identification information stored in the first print management server 100A based on the issuance source information. Then, the second print management server 100B executes print processing based on the acquired print data. For this reason, even if a print instruction designating job identification information is issued to a print management device other than a print management device that stores print data, it is possible to acquire print data corresponding to the job identification information and execute print processing based on the acquired print data. Therefore, the convenience for the user can be increased.

The transfer control unit 255 specifies, based on the issuance source information included in the job identification information inquired from the second print management server 100B, the first print management server 100A that stores the print data. The transfer control unit 255 transmits the job identification information and a transfer request to the second print management server 100B to the specified first print management server 100A. The first print management server 100A receives the job identification information and the transfer request from the service linking server 200 and transmits the print data corresponding to the job identification information to the second print management server 100B based on the transfer request. Therefore, it is possible to cause the second print management server 100B to print the print data corresponding to the job identification information.

The transfer control unit 255 specifies, based on the issuance source information included in the job identification information, the first print management server 100A that stores the print data. The transfer control unit 255 receives the print data from the specified first print management server 100A and transmits the received print data to the second print management server 100B. Therefore, it is possible to cause the second print management server 100B to print the print data corresponding to the job identification information.

When the issuance source information included in the job identification information does not indicate the second print management server 100B itself, the second print management server 100B inquires of the service linking server 200 about the job identification information. For this reason, only when the second print management server 100B does not store the print data, it is possible to inquire the service linking server 200 about the job identification information and acquire print data stored by the other print management server 100.

The first print management server 100A includes the first print control unit 157A.

The first print management server 100A determines whether the issuance source information included in the job identification information of the received print instruction indicates the first print management server 100A and, when the issuance source information indicates the first print management server 100A, acquires the print data corresponding to the job identification information from the first storage unit 140A and causes the first print control unit 157A to execute print processing based on the acquired print data. Accordingly, when the issuance source information included in the job identification information of the received print instruction indicates the first print management server 100A itself, the print data can be acquired from the first storage unit 140A and the print processing can be executed.

The second print management server 100B includes a second communication unit 110B that receives print data, a second storage unit 140B that stores the print data, and a second issuance unit 151B that issues job identification information to the print data.

The second print management server 100B determines whether the issuance source information included in the job identification information of the received print instruction indicates the second print management server 100B and, when the issuance source information indicates the second print management server 100B, acquires the print data corresponding to the job identification information from the second storage unit and causes the second print control unit 157B to execute print processing based on the acquired print data. Therefore, when the issuance source information included in the job identification information of the received print instruction indicates the second print management server 100B itself, it is possible to acquire the print data from the second storage unit 140B and execute the print processing.

When the issuance source information indicates the second print management server 100B, the second print management server 100B causes the display device of the store device 25 to display print cost required for printing. When the issuance source information does not indicate the second print management server 100B, the second print management server 100B causes the display device provided in the store device 25 to display the print cost and transfer cost required for data transfer or total cost of the print cost and the transfer cost. Therefore, it is possible to cause the user to grasp cost required for printing.

The service linking server 200 calculates the transfer cost and transmits the calculated transfer cost to the second print management server 100B. The service linking server 200 acquires the transfer cost from the second print management server 100B and distributes cost of the first print management server 100A in the acquired transfer cost to the first print management server 100A. Therefore, the cost of the first print management server 100A in the transfer cost is distributed to the first print management server 100A. The data transfer cost can be distributed to the service linking server 200 and the first print management server 100A.

### 6. Other Configurations

Units of processing in the flowcharts of FIGS. 8 and 10 are divided according to details of main processing content in order to facilitate understanding of the processing of the print management server 100. The present disclosure is not limited by a way of division and names of the processing units illustrated in the flowcharts of FIGS. 8 and 10. The processing of the print management server 100 can also be divided into more processing units according to processing content or can be divided such that one processing unit includes more processing. Processing order of the flowcharts explained above is not limited to the illustrated example.

The same applies to processing units of the service linking server 200 illustrated in FIG. 9.

The functional units of the print management server 100 illustrated in FIGS. 2 and 3 and the service linking server 200 illustrated in FIG. 5 indicate functional components implemented by cooperation of hardware and software. A specific implementation form is not particularly limited. That is, hardware individually corresponding to the individual functional units does not always need to be implemented. It is naturally possible that one processor executes a program to implement functions of a plurality of functional units. A part of functions implemented by software in the embodiment explained above may be implemented by hardware or a part of functions implemented by hardware in the embodiment may be implemented by software.

When the present disclosure is implemented using a computer, a program to be executed by the computer can also be configured in a form of a recording medium. The program to be executed by the computer can be configured in a form of a transmission medium for transmitting the program. As the recording medium, a magnetic or optical recording medium or a semiconductor memory device can be used. Specifically, examples of the recording medium include a portable or stationary recording medium such as a flexible disc, an HDD, a compact disk read-only memory (CD-ROM), a digital versatile disk (DVD), a Blu-ray disc, a magneto-optical disc, a flash memory, or a card-type recording medium. The recording medium may be a nonvolatile storage device such as a RAM, a ROM, or an HDD that is an internal storage device provided in a server device. Blu-ray is a registered trademark.

The second communication unit 110B of the second print management server 100B is equivalent to a second reception unit and the second storage unit 140B of the second print management server 100B is equivalent to a second storage unit. The second issuance unit 151B of the second print management server 100B is equivalent to a second issuance unit.

### 7. Summary of the Present Disclosure

A summary of the present disclosure is appended below.

### Appendix 1

An integrated printing system including: a first print management device including: a first reception unit configured to receive print data; a first storage unit configured to store the print data; a first issuance unit configured to issue identification information of a job corresponding to the print data, the identification information being job identification information including issuance source information indicating a print management device at an issuance source of the job; and a first transmission unit configured to transmit the job identification information to a user at a transmission source of the print data and a service linking device that manages the job identification information; the service linking device including: an information acquisition unit configured to acquire the job identification information from the first print management device; and a management unit configured to manage the job identification information; and a second print management device including: a second acquisition unit configured to, when receiving a print instruction designating the job identification information, transmit the job identification information to the service linking device and acquire, from the print management device indicated by the issuance source information included in the job identification information, print data corresponding to the designated job identification information; and a second print control unit configured to execute print processing based on the acquired print data, in which the service linking device includes a transfer control unit configured to acquire the issuance source information included in the job identification information received from the second print management device and transfers, to the second print management device, the print data corresponding to the job identification information stored by the first print management device indicated by the acquired issuance source information.

With this configuration, when receiving the print instruction designating the job identification information, the second print management device inquires the service linking device about the job identification information, the service linking device specifies the issuance source information based on the job identification information and transfers the print data corresponding to the job identification information stored in the first print management device based on the issuance source information to the second print management device. Then, the second print management device executes the print processing based on the acquired print data. For this reason, even if a print instruction designating job identification information is issued to a print management device other than a print management device that stores print data, it is possible to acquire print data corresponding to the job identification information and execute print processing based on the acquired print data. Therefore, the convenience for the user can be increased.

### Appendix 2

The integrated printing system described in the appendix 1, in which the transfer control unit of the service linking device specifies, based on the issuance source information included in the job identification information inquired from the second print management device, the first print management device storing the print data and transmits the job identification information and a transfer request to the second print management device to the specified first print management device, and the first print management device receives the job identification information and the transfer request from the service linking device and transmits the print data corresponding to the job identification information to the second print management device based on the transfer request.

With this configuration, the first print management device that stores the print data is specified based on the issuance source information included in the job identification information and the job identification information and the transfer request to the second print management device are transmitted to the specified first print management device. Therefore, it is possible to cause the second print management device to print the print data corresponding to the job identification information.

### Appendix 3

The integrated printing system described in the appendix 1, in which the transfer control unit of the service linking device specifies, based on the issuance source information included in the job identification information inquired from the second print management device, the first print management device storing print data, receives print data from the first print management device, and transmits the received print data to the second print management device.

With this configuration, the first print management device that stores the print data is specified based on the issuance source information included in the job identification information and the print data is transmitted from the specified first print management device to the second print management device. Therefore, it is possible to cause the second print management device to print the print data corresponding to the job identification information.

### Appendix 4

The integrated printing system described in the appendix 1, in which the second print management device determines whether the issuance source information included in the job identification information of the received print instruction indicates the second print management device and, when the issuance source information does not indicate the second print management device, inquires the service linking device about the job identification information.

With this configuration, when the issuance source information included in the job identification information does not indicate the second print management device itself, the second print management device inquires the service linking device about the job identification information. For this reason, only when the second print management device does not store the print data, it is possible to inquire the service linking device about the job identification information and acquire the print data stored by another print management device.

### Appendix 5

The integrated printing system described in any one of the appendixes 1 to 4, in which the first print management device includes a first print control unit configured to determine whether the issuance source information included in the job identification information of the received print instruction indicates the first print management device, acquire print data corresponding to the job identification information from the first storage unit when the issuance source information indicates the first print management device, and execute the print processing based on the acquired print data, the second print management device includes: a second reception unit configured to receive the print data; a second storage unit configured to store the print data; and a second issuance unit configured to issue the job identification information to the print data, and the second print control unit determines whether the issuance source information included in the job identification information of the received print instruction indicates the second print management device and, when the issuance source information indicates the second print management device, acquires the print data corresponding to the job identification information from the second storage unit and executes the print processing based on the acquired print data.

With this configuration, when the issuance source information included in the job identification information indicates the first and second print management devices themselves, the first and second print management devices acquire the print data from the first storage unit or the second storage unit and execute the print processing based on the acquired print data. For this reason, when the issuance source information indicates itself, it is possible to acquire the print data from the first storage unit or the second storage unit and execute the print processing.

### Appendix 6

The integrated printing system described in the appendix 5, in which, when the issuance source information indicates the second print management device, the second print management device causes a display device to display print cost required for printing, and, when the issuance source information does not indicate the second print management device, the second print management device causes the display device to display the print cost and transfer cost required for data transfer or a total cost of the print cost and the transfer cost.

With this configuration, when the second print management device stores the print data, the second print management device causes the display apparatus to display the print cost and, when the second print management device does not store the print data, the second print management device causes the display device to display the print cost and the transfer cost required for data transfer or the total cost of the print cost and the transfer cost. Therefore, it is possible to cause the user to grasp cost required for printing.

### Appendix 7

The integrated printing system described in the appendix 6, in which the service linking device calculates the transfer cost, transmits the calculated transfer cost to the second print management device, acquires the transfer cost from the second print management device, and distributes cost of the first print management device in the acquired transfer cost to the first print management device.

With this configuration, the cost of the first print management device in the transfer cost is distributed to the first print management device. Therefore, the data transfer cost can be distributed to the service linking device and the first print management device.

### Appendix 8

A service linking device including: an information acquisition unit configured to acquire, from a print management device that stores print data, identification information of a job corresponding to the print data, the identification information being job identification information including issuance source indicating the print management device that is an issuance source of the job; a third storage unit configured to store the job identification information acquired by the information acquisition unit and identification information of the print management device indicated by the issuance source information; and a transfer control unit configured to acquire the issuance source information included in the job identification information received from another print management device and transfer, to the other print management device, the print data corresponding to the job identification information stored by the print management device indicated by the acquired issuance source information.

With this configuration, when receiving an inquiry specifying the job identification information, the service linking device specifies, based on the issuance source information included in the job identification information, the print management device storing the print data and transmits the job identification information and the print data transfer request to the specified print management device. For this reason, even a print management device not storing the print data can acquire the print data corresponding to the job identification information and execute print processing based on the acquired print data. Therefore, the convenience for the user can be increased.

### Appendix 9

A print management device including: a first reception unit configured to receive print data; a first storage unit configured to store the print data; and a first issuance unit configured to issue identification information of a job corresponding to the print data, the identification information being job identification information including issuance source information indicating a print management device at an issuance source of the job, the print management device transmitting the job identification information to a user at a transmission source of the print data and a service linking device that manages the job identification information and, when receiving the job identification information and a transfer request for the print data, transmitting the print data corresponding to the job identification information to another print management device designated by the transfer request.

With this configuration, when the print management device receives the job identification information and the transfer request for the print data, the print data corresponding to the job identification information is transmitted to another print management device designated by the transfer request. For this reason, even when a print instruction designating the job identification information is issued to a print management device not storing print data, it is possible to acquire the print data corresponding to the job identification information and execute print processing based on the acquired print data. Therefore, the convenience for the user can be increased.

### Appendix 10

A print management device comprising: a second acquisition unit configured to, when receiving a print instruction designating identification information of a job corresponding to print data, the identification information being job identification information including issuance source information indicating a print management device at an issuance source of the job, inquire a service linking device, which manages the job identification information, about the job identification information and acquire, from the print management device indicated by the issuance source information included in the job identification information, the print data corresponding to the designated job identification information; and a second print control unit configured to execute print processing based on the acquired print data.

With this configuration, when the print instruction designating the job identification information is received, the print data corresponding to the specified job identification information can be acquired from the print management device indicated by the issuance source information included in the job identification information by inquiring the service linking device managing the job identification information about the job identification information. By executing print processing based on the acquired print data, even if a print instruction designating the job identification information is issued to a print management device other than the print management device storing the print data, it is possible to acquire the print data corresponding to the job identification information and execute the print processing based on the acquired print data. Therefore, the convenience for the user can be increased.

What is claimed is:

1. An integrated printing system including:
a first print management device including:
a first reception unit configured to receive print data;
a first storage unit configured to store the print data;
a first issuance unit configured to issue identification information of a job corresponding to the print data, the identification information being job identification information including issuance source information indicating a print management device at an issuance source of the job; and
a first transmission unit configured to transmit the job identification information to a user at a transmission source of the print data and a service linking device that manages the job identification information;
the service linking device including:
an information acquisition unit configured to acquire the job identification information from the first print management device; and
a management unit configured to manage the job identification information; and
a second print management device including:
a second acquisition unit configured to, when receiving a print instruction designating the job identification information, transmit the job identification information to the service linking device and acquire, from the print management device indicated by the issuance source information included in the job identification information, print data corresponding to the designated job identification information; and
a second print control unit configured to execute print processing based on the acquired print data, wherein
the service linking device includes a transfer control unit configured to acquire the issuance source information included in the job identification information received from the second print management device and transfers, to the second print management device, the print data corresponding to the job identification information stored by the first print management device indicated by the acquired issuance source information.

2. The integrated printing system according to claim 1, wherein
the transfer control unit of the service linking device specifies, based on the issuance source information included in the job identification information inquired from the second print management device, the first print management device storing the print data and transmits the job identification information and a transfer request to the second print management device to the specified first print management device, and
the first print management device receives the job identification information and the transfer request from the service linking device and transmits the print data corresponding to the job identification information to the second print management device based on the transfer request.

3. The integrated printing system according to claim 1, wherein the transfer control unit of the service linking device specifies, based on the issuance source information included in the job identification information inquired from the second print management device, the first print management device storing print data, receives print data from the first print management device, and transmits the received print data to the second print management device.

4. The integrated printing system according to claim 1, wherein the second print management device determines whether the issuance source information included in the job identification information of the received print instruction is the second print management device, and inquires of the service linking device about the job identification information when the issuance source information does not indicate the second print management device.

5. The integrated printing system according to claim 1, wherein
the first print management device includes a first print control unit configured to determine whether the issuance source information included in the job identification information of the received print instruction indicates the first print management device, acquire print data corresponding to the job identification information from the first storage unit when the issuance source information indicates the first print management device, and execute the print processing based on the acquired print data,
the second print management device includes:
a second reception unit configured to receive the print data;
a second storage unit configured to store the print data; and
a second issuance unit configured to issue the job identification information to the print data, and
the second print control unit determines whether the issuance source information included in the job identification information of the received print instruction indicates the second print management device and, when the issuance source information indicates the second print management device, acquires the print data corresponding to the job identification information from the second storage unit and executes the print processing based on the acquired print data.

6. The integrated printing system according to claim 5, wherein
when the issuance source information indicates the second print management device, the second print management device causes a display device to display print cost required for printing, and
when the issuance source information does not indicate the second print management device, the second print management device causes the display device to display the print cost and transfer cost required to data transfer or a total cost of the print cost and the transfer cost.

7. The integrated printing system according to claim 6, wherein the service linking device calculates the transfer cost, transmits the calculated transfer cost to the second print management device, acquires the transfer cost from the second print management device, and distributes cost of the first print management device in the acquired transfer cost to the first print management device.

8. A service linking device comprising:
an information acquisition unit configured to acquire, from a print management device that stores print data, identification information of a job corresponding to the print data, the identification information being job identification information including issuance source indicating the print management device that is an issuance source of the job;
a third storage unit configured to store the job identification information acquired by the information acquisition unit and identification information of the print management device indicated by the issuance source information; and
a transfer control unit configured to acquire the issuance source information included in the job identification information received from another print management device and transfer, to the other print management device, the print data corresponding to the job identification information stored by the print management device indicated by the acquired issuance source information.

9. A print management device comprising:
a first reception unit configured to receive print data;
a first storage unit configured to store the print data; and
a first issuance unit configured to issue identification information of a job corresponding to the print data, the identification information being job identification information including issuance source information indicating a print management device at an issuance source of the job,
the print management device transmitting the job identification information to a user at a transmission source of the print data and a service linking device that manages the job identification information, and
when receiving the job identification information and a transfer request for the print data, transmitting the print data corresponding to the job identification information to another print management device designated by the transfer request.
